(19) United States
(12) Patent Application Publication
(10) Pub. No.: US 2011/0173946 A1
(43) Pub. Date: Jul. 21, 2011

(54) CABLE OR THE LIKE PROTECTING AND GUIDING DEVICE

(75) Inventor: Katsuhide YAMASHITA, Osaka (JP)

(73) Assignee: TSUBAKIMOTO CHAIN CO., Osaka (JP)

(21) Appl. No.: 13/006,972

(22) Filed: Jan. 14, 2011

(30) Foreign Application Priority Data
Jan. 19, 2010 (JP) 2010-009220

(51) Int. Cl. H02G 11/00

(52) U.S. Cl. 59/78.1

(57) ABSTRACT

The invention provides a cable protecting and guiding device with a reduced radius of flexion formed when the device is bent back in a cable longitudinal direction between cable fixing and moving ends and which attains a smooth movement by continuously sliding along slidable-contact bottom portions of shoes disposed on upper and lower parts of the flexed cable inner peripheral side. A slidable-contact bottom portion of a shoe provided on the flexed cable inner peripheral side of a pair of link plates disposed apart in the lateral direction has a parallelogram slidable-contact bottom surface that slidably contacts between upper and lower shoes on the flexed cable inner peripheral side.

### CROSS REFERENCE TO RELATED APPLICATIONS

This application claims the foreign priority benefit under Title 35, United States Code, §119 (a)-(d) of Japanese Patent Application No. 2010-009220, filed on Jan. 19, 2010 in the Japan Patent Office, the disclosure of which is herein incorporated by reference in its entirety.

### BACKGROUND OF THE INVENTION

1. Field of the Invention

The present invention relates to a protecting and guiding device for a cable or the like. More specifically, the present invention relates to a protecting and guiding device for a cable or the like which securely and steadily protects and guides flexible cables and the like. Examples of cables which may be used in accordance with the present invention include an electrical cable for transmitting electrical signals or supplying power and a hose for supplying hydraulic pressure and air pressure by connecting a mobile part with a stationary part of industrial machines and vehicles.

2. Related Art

A prior art cable protecting and guiding device is constructed by connecting a large number of link frames. Each link frame is composed of a pair of right and left link plates disposed apart with connecting plates bridged respectively across the link plates of flexed cable outer and inner peripheral sides. A large number of the link frames are connected in a cable longitudinal direction while restricting a radius of flexion thereof so that the radius of flexion does not fall below a certain value.

Such type of device is also provided with shoes disposed on the link plates on the flexed cable inner peripheral side which are used to prevent noise and wear from being generated between the upper and lower link plates on the flexed cable inner peripheral sides that come directly in contact with each other when the flexed cable is folded back in the cable longitudinal direction with a lengthy moving stroke.

FIGS. 12 through 15 illustrate a prior art cable protecting and guiding device currently known in the art. The known cable and cable protecting and guiding device including shoes 540 whose slidable-contact bottom portion 541 has a rectangular slidable-contact bottom surface 541a that, as shown in FIG. 15, slidably contacts an opposing bottom surface 541a on the flexed cable inner peripheral side. Therefore, the slidable-contact bottom portions 541 of the shoes 540 adjacent in the cable longitudinal direction contact and interfere with each other and a radius of flexion increases in bending back and moving the device in the cable longitudinal direction between cable fixing and moving ends. As a result, there has been a problem that it is unable to downsize the device due to the increase of the radius of flexion required in bending back the device.

Still more, although it might be possible to make the device in compact by reducing the radius of flexion in bending back the device by reducing a size of the rectangular slidable-contact bottom surface 541a in the cable longitudinal direction, the opposing slidable-contact bottom portions 541 of the shoes 540 of the upper and lower sides of the flexed cable inner peripheral side tend to engage convex-concavely and to hamper continuous slidable-contact operations. Accordingly, there has been a problem that it is unable to attain smooth relative move of a train of the link frames bent back in the cable longitudinal direction between the cable fixing and moving ends.

### SUMMARY OF THE INVENTION

Accordingly, the present invention aims at solving the aforementioned prior art problems by providing a cable protecting and guiding device that may be downsized by reducing a radius of flexion created when the device is bent back in the cable longitudinal direction between cable fixing and moving ends and which attains smooth movement of upper and lower trains of link frames by continuously sliding along slidable-contact bottom portions of shoes disposed on upper and lower sides of the flexed cable inner peripheral side of the device.

In order to solve the aforementioned problems, a first aspect of the invention provides a cable protecting and guiding device having a large number of link frames having the following characteristics. That is, each link frame is composed of a pair of link plates disposed apart in a lateral direction of the device and connecting plates bridged respectively across flexed cable outer and inner peripheral sides of the link plates. The large number of link frames are linked respectively in a cable longitudinal direction. Cables and the like inserted through the link frames and the surrounding link frames are bent back and are moved together in the cable longitudinal direction between cable fixing and moving ends.

A slidable-contact bottom portion of a shoe provided to the link plate of the flexed cable inner peripheral side has a slidable-contact bottom surface shaped like a parallelogram that slidably contacts with a slidable-contact bottom surface of another shoe of another link frame on the flexed cable inner peripheral side when the link frames are bent back and moved together in the stacked manner.

A second aspect of the invention solves the aforementioned problems by arranging such that the parallelogram slidable-contact bottom surfaces of the pair of right and left link plates are disposed so as to orient mutually in the same direction. A third aspect of the invention solves the aforementioned problems by arranging such that the parallelogram slidable-contact bottom surfaces of the pair of right and left link plates are disposed so as to orient symmetrically with each other.

The invention has many advantageous effects. Specifically, because the slidable-contact bottom portion of the shoe provided on the link plate on the flexed cable inner peripheral side has the parallelogram slidable-contact bottom surface that slidably contacts with a slidable-contact bottom surface of another shoe facing up and down against each other on the flexed cable inner peripheral side and opposite sides of the parallelogram composing the slidable-contact bottom surface are staggered diagonally in parallel, i.e., sides in the longitudinal direction of the parallelogram may be shortened as compared to the prior art rectangular shoes, each mutual gap in the cable longitudinal direction between the adjacent shoes increases by that and a degree of freedom of flexibility of the upper and lower adjacent shoes on the flexed cable inner peripheral side increases.

Accordingly, it becomes possible to reduce a radius of flexion for bending back the shoes in the cable longitudinal direction between the cable fixing and moving ends while keeping smooth relative move of the shoes of the train of link frames bent back in the cable longitudinal direction by continuously sliding the slidable-contact bottom portions of the shoes facing up and down against each other on the flexed cable inner peripheral side. Thus, it becomes possible to downsize the device.

The cable protecting and guiding device of the second aspect of the invention has additional advantageous effects because the parallelogram slidable-contact bottom surfaces of the pair of right and left link plates are disposed so as to orient mutually in the same direction, so different shoes are not necessary for the pair of right and left link plates. Accordingly, the shoes may be one type having the same shape and it becomes possible to suppress an increase of numbers of parts and to lessen a burden for managing the parts.

The cable protecting and guiding device of the third aspect of the invention has such advantageous effects that because the parallelogram slidable-contact bottom surfaces of the pair of right and left link plates are disposed so as to orient symmetrically in the lateral direction with each other, the slidable-contact bottom portions of the shoes facing at the upper and lower parts of the flexed cable inner peripheral side slidably contact evenly in the lateral direction between the pair of right and left link plates. Accordingly, it becomes possible to realize a stable relative movement of the bent-back link frames without obliquely moving with each other in the cable longitudinal direction.

### BRIEF DESCRIPTION OF DRAWINGS

FIG. 1 is a schematic view showing a flexed state of a cable protecting and guiding device of a first embodiment of the invention;

FIG. 2 is an enlarged perspective view of a link frame and a shoe in FIG. 1;

FIGS. 3A and 3B are perspective views of the shoe shown in FIG. 1;

FIG. 4 is a partially cutaway perspective view showing a state of the shoe attached to the link frame shown in FIG. 1;

FIG. 5 is a perspective view showing a state how upper and lower shoes of the device of the first embodiment slidably come into contact with each other;

FIG. 6 is a schematic view showing a flexed state of a cable protecting and guiding device of a second embodiment of the invention;

FIG. 7 is an enlarged perspective view of a link frame and a shoe shown in FIG. 6;

FIGS. 8A and 8B are perspective views showing one shoe shown in FIG. 6;

FIGS. 9A and 9B are perspective views showing another shoe shown in FIG. 6;

FIG. 10 is a perspective view showing, while cutting parts of the shoe and the link frame shown in FIG. 6, a state of the shoe attached to the link frame;

FIG. 11 is a perspective view showing a state how upper and lower shoes of the device of the second embodiment slidably come into contact with each other;

FIG. 12 is a schematic view showing a flexed state of a prior art cable protecting and guiding device;

FIG. 13 is an enlarged perspective view of a link frame and a shoe shown in FIG. 12;

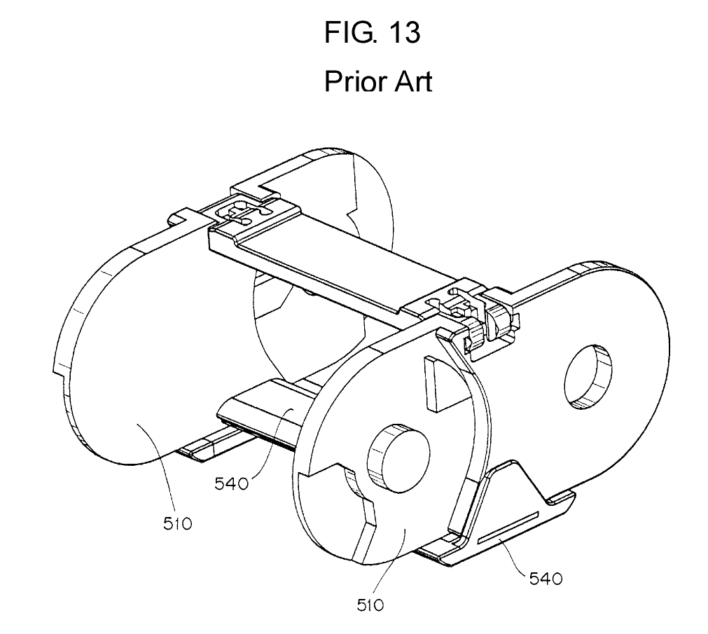

FIGS. 14A and 14B are perspective views of the shoe shown in FIG. 12; and

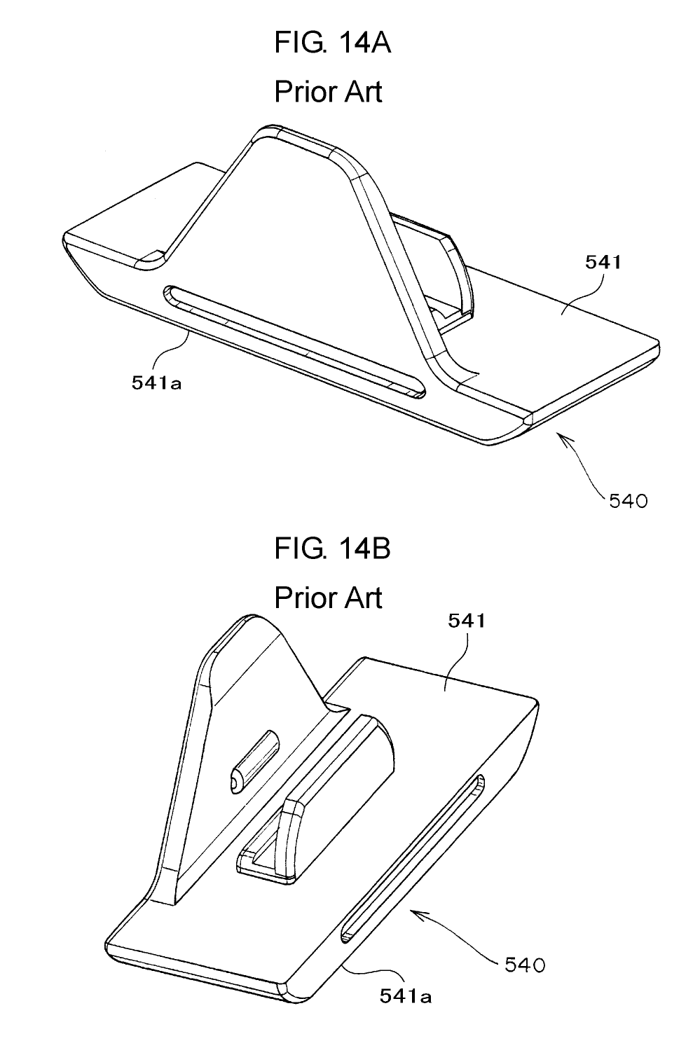

FIG. 15 is a perspective view showing a state how upper and lower shoes in the prior art cable protecting and guiding device slidably contact.

### BEST MODE FOR CARRYING OUT THE INVENTION

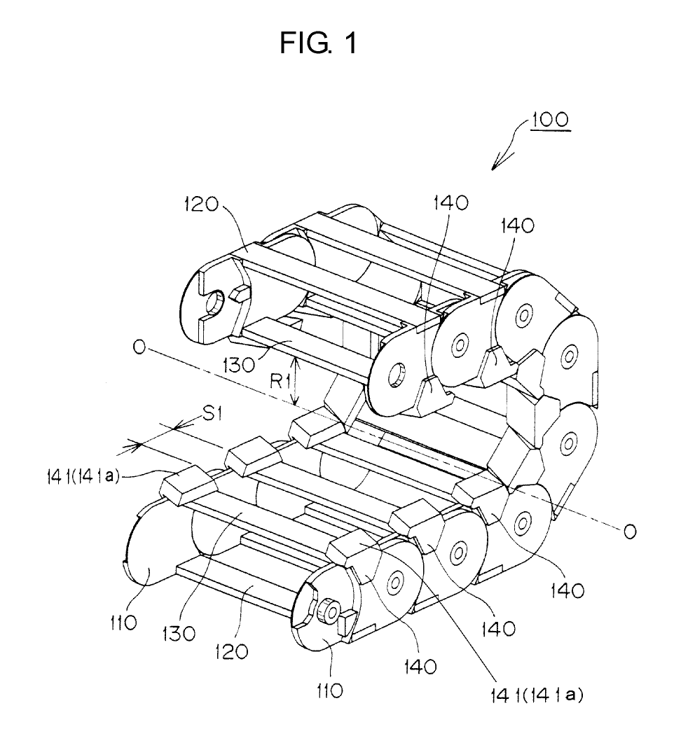

A first embodiment of a cable protecting and guiding device of the invention will be explained with reference to FIGS. 1 through 11.

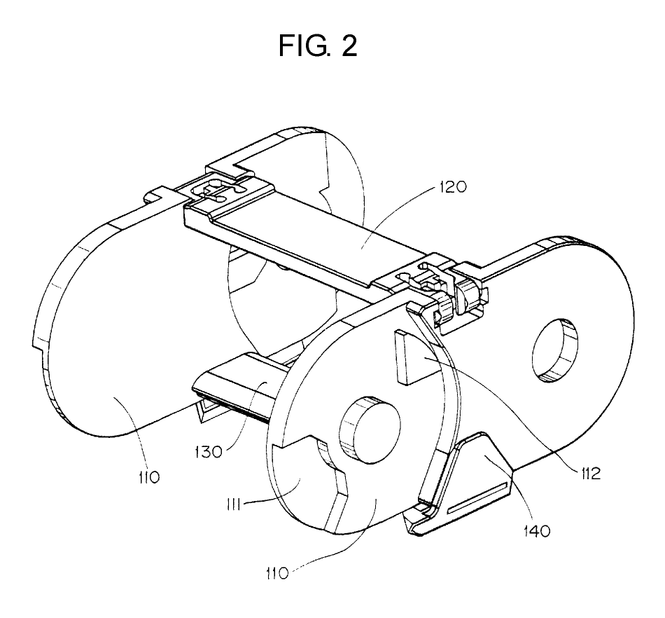

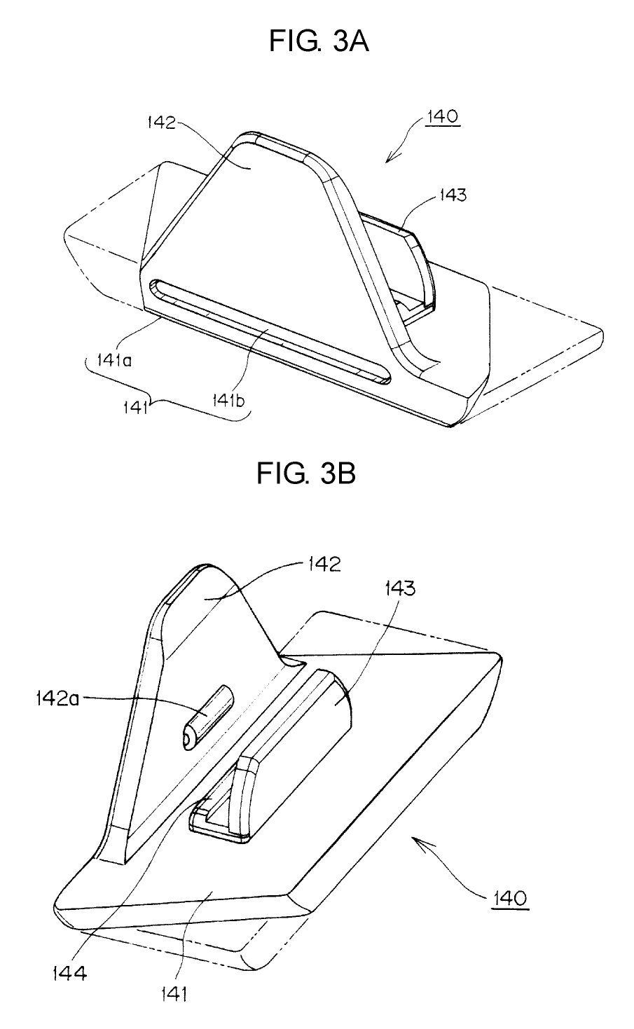

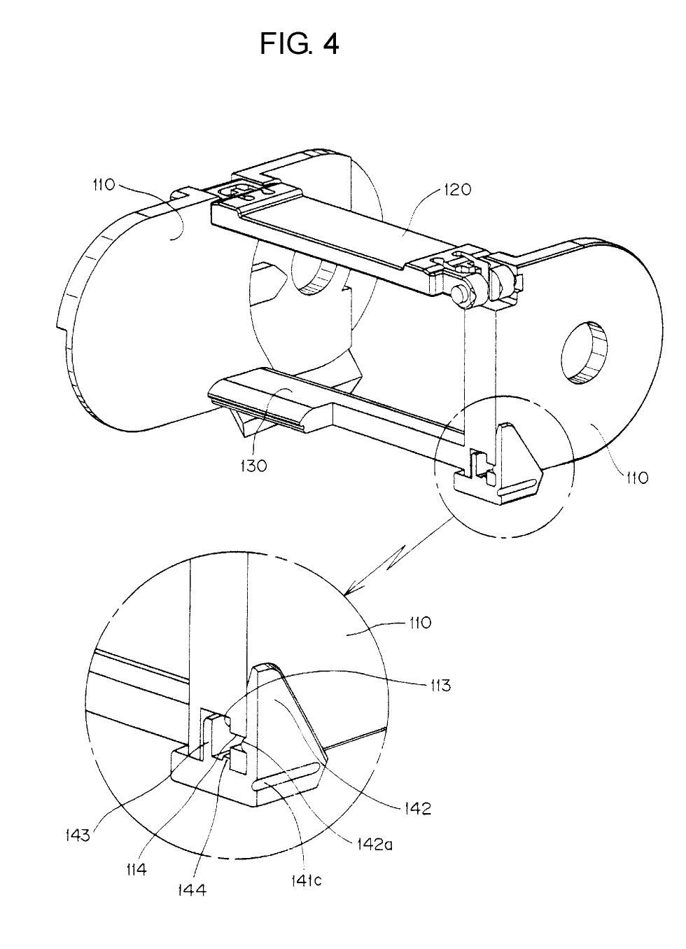

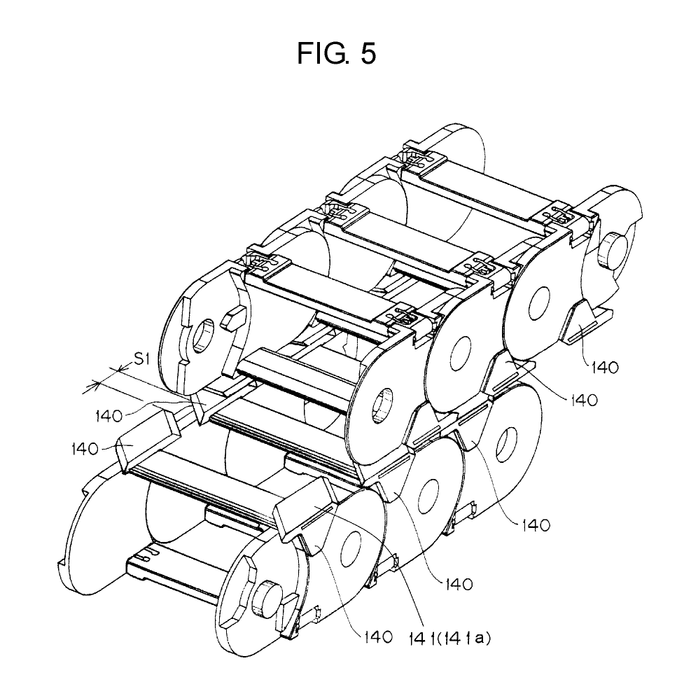

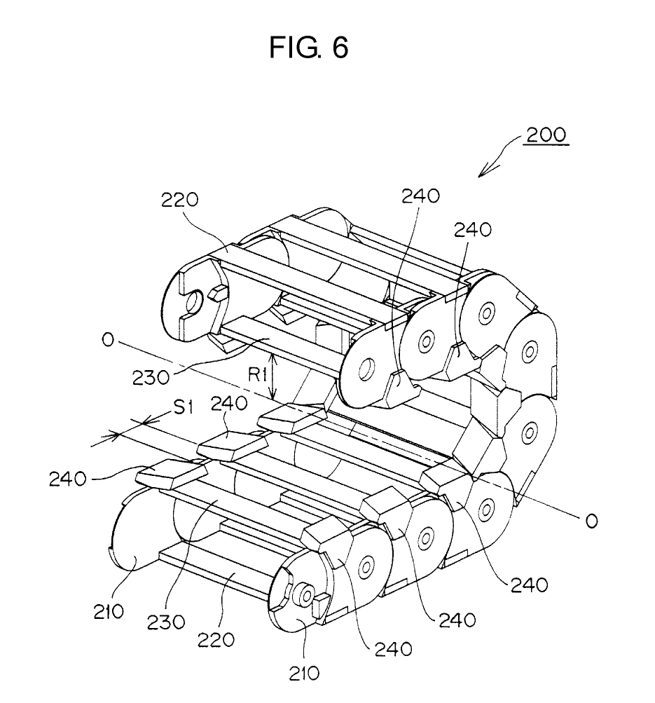

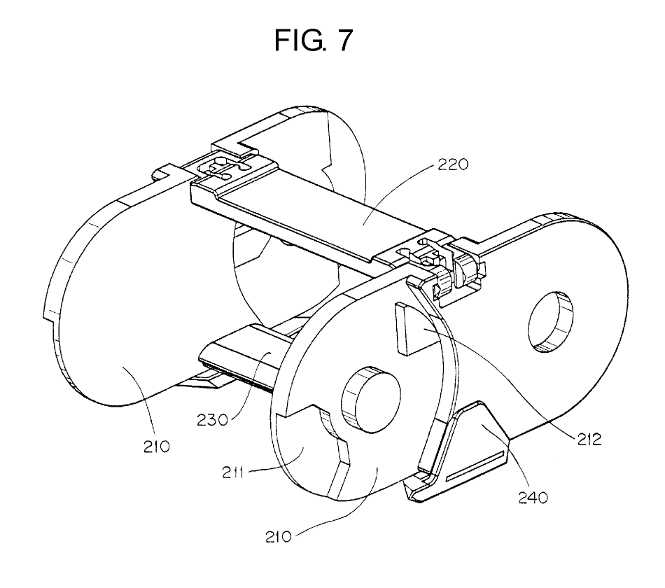

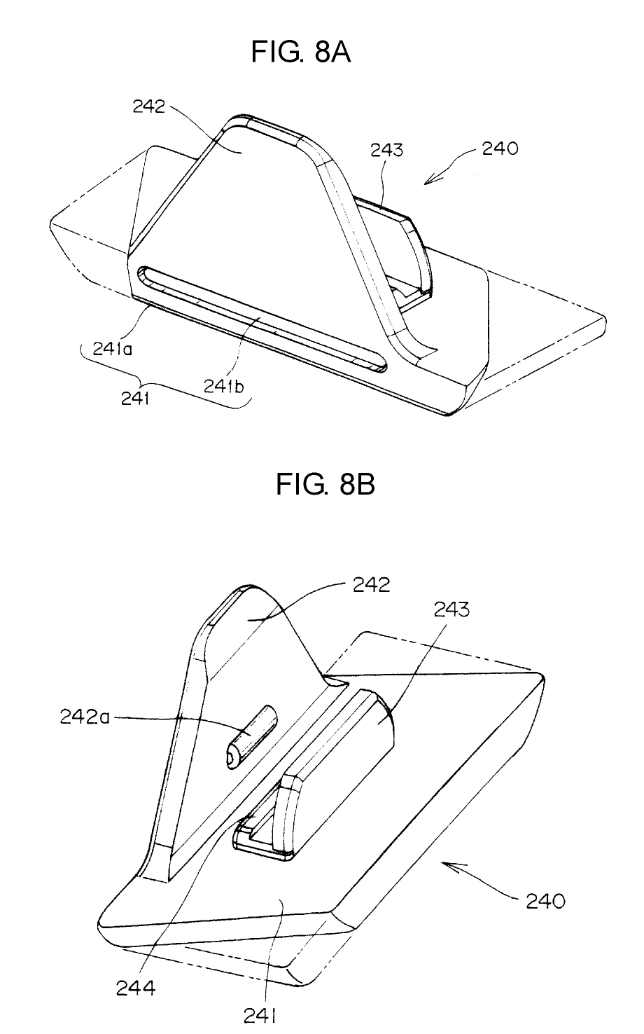

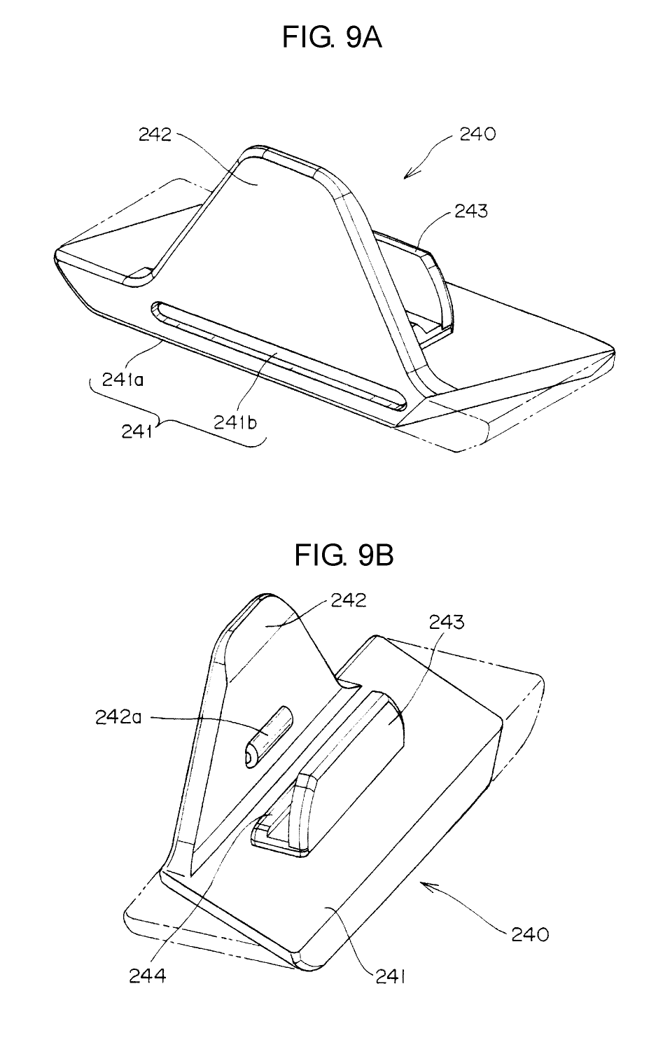

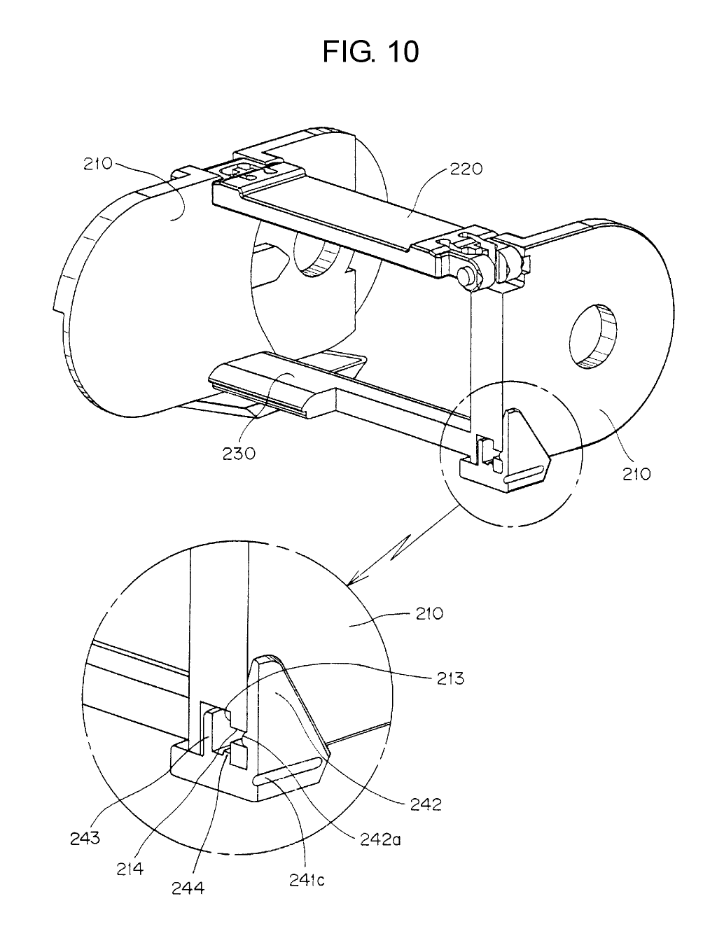

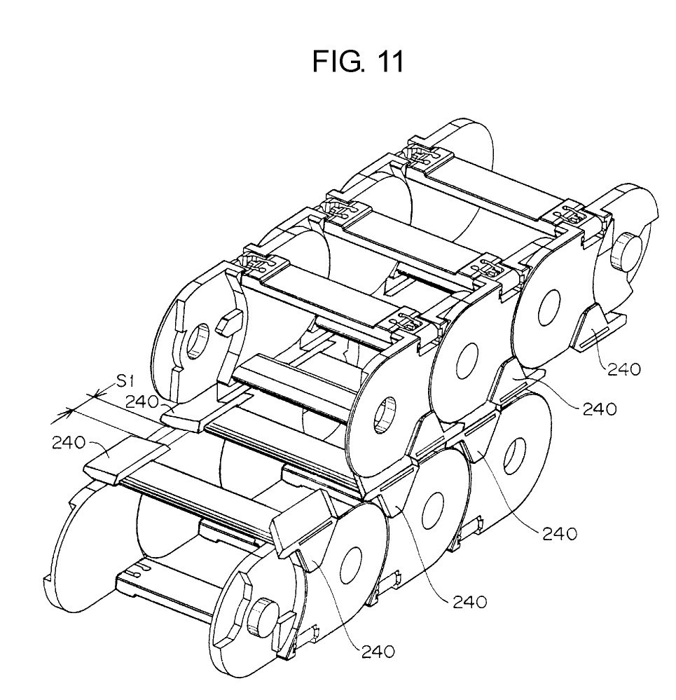

FIG. 1 is a schematic view showing a flexed state of the cable protecting and guiding device of the first embodiment of the invention, FIG. 2 is an enlarged perspective view of a link frame and a shoe shown in FIG. 1, FIGS. 3A and 3B are perspective views of the shoe shown in FIG. 1, FIG. 4 is a partially cutaway perspective view showing a state of the shoe attached to the link frame shown in FIG. 1, FIG. 5 is a perspective view showing a state how upper and lower shoes of the device of the first embodiment slidably contact, FIG. 6 is a schematic view showing a flexed state of a cable protecting and guiding device of a second embodiment of the invention, FIG. 7 is an enlarged perspective view of a link frame and a shoe shown in FIG. 6, FIGS. 8A and 8B are perspective views showing one shoe shown in FIG. 6, FIGS. 9A and 9B are perspective views showing another shoe shown in FIG. 6, FIG. 10 is a partially cutaway perspective view showing a state of the shoe attached to the link frame shown in FIG. 6 and FIG. 11 is a perspective view showing a state how upper and lower shoes of the device of the second embodiment slidably contact.

As shown in FIG. 1, the cable protecting and guiding device 100 of the first embodiment of the invention is composed of a large number of link frames respectively connected in a cable longitudinal direction. Each link frame is composed of a pair of link plates 110 disposed apart in a lateral direction of the device and connecting plates 120 and 130 bridged respectively across these link plates 110 on the flexed cable outer and inner peripheral sides. The device 100 is arranged so that cables and the like (not shown) inserted through the link frames may be bent back in the cable longitudinal direction and be moved relatively between a cable fixing end not shown and a cable moving end (not shown).

Here, as shown in FIG. 2, a cutaway portion 111 and a convex portion 112 of the link plate 110 described above are arranged so that when a link frame is linked with an adjacent link frame, the cutaway portion 111 engages with the convex portion 112 of the adjacent link frame while the convex portion 112 engages with the cutaway portion 111 of the adjacent link frame. Thereby, a radius of flexion in the cable longitudinal direction is restricted so that it does not fall below a certain value.

While a material of the link plates 110, the connecting plates 120 and 130 is not specifically limited, it is preferable that the plates 110, 120, and 132 are molded and fabricated using a glass fiber reinforced polyamide resin that exhibits excellent strength.

Next, a shoe 140 made of synthetic resin and provided on the flexed cable inner peripheral side of the link plate 110, which is the most characteristic part of the device 100 of the present embodiment, will be explained in detail. That is, the shoe 140 shown in FIGS. 3A and 3B has a slidable-contact bottom portion 141 having a slidable-contact bottom surface 141a formed into a shape of parallelogram that slidably contacts with a shoe 140 of an opposing upper or lower link plate 110 on the flexed cable inner peripheral side. The shoe 140 also has a shoe outer wall portion 142 protruding from the slidable-contact bottom portion 141 to the side of the link plate 110 and a shoe inner wall portion 143 that removably engages with the link plate 110 in cooperation with the shoe outer wall portion 142.

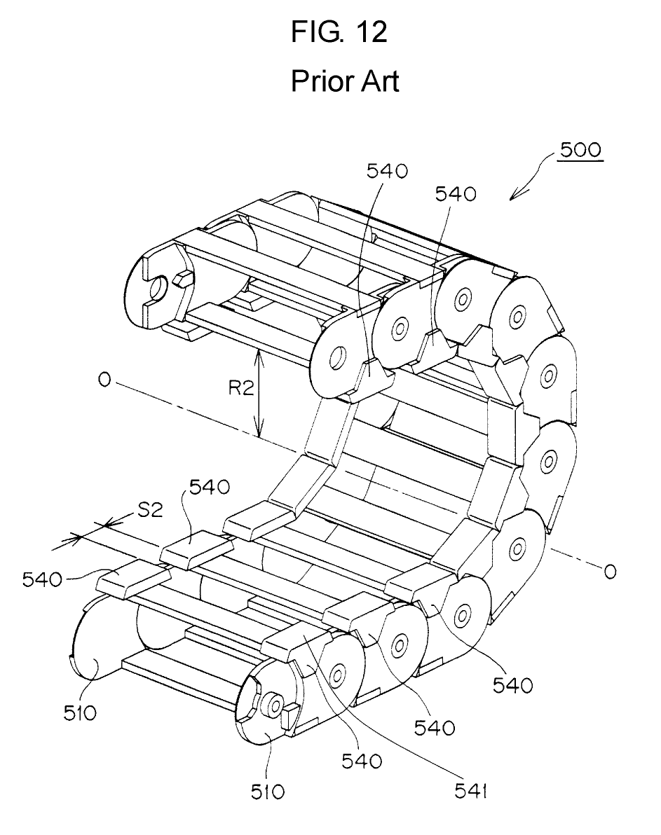

Thereby, as shown in FIG. 1, a mutual distance S1 in the cable longitudinal direction between the adjacent shoes 140 on the flexed cable inner peripheral side are lengthened by the distance by which opposite sides of the parallelogram composing the slidable-contact bottom surface 141a are staggered diagonally in parallel with each other, i.e., by the length that the sides in the longitudinal direction of the parallelogram are shortened. As a result, as compared with the distance S2 shown in FIG. 12, the degree of freedom of flexibility of the link plates of the present invention is increased. It is noted that imaginary lines in FIGS. 3A and 3B indicate an outer shape of the slidable-contact bottom portion 541 of the prior art shoe 510 to compare with the outer shape of the shoe 140 of the present embodiment.

The parallelogram slidable-contact bottom surfaces 141a of the shoes 140 described above are disposed so as to orient in the same direction among the pair of right and left link plates 110. That is, because the present embodiment does not require different kinds of shoes for each of the pair of right and left link plates 110, the shoes 140 disposed on the right and left link plates are the same parts having a single shape.

It is noted that the shoe 140 shown in FIGS. 3 and 4 has a horizontally long hook 142a provided on an inner side surface of the shoe outer wall portion 142 described above, a horizontally long projection 144 provided closely with the shoe inner wall portion 143 described above, an indicator 141b provided on a side surface of the slidable-contact bottom portion 141 described above to check a state of wear of the shoe, an insertion hole 113 into which the shoe inner wall portion 143 and the projection 144 described above are inserted and a concave 114 with which the hook 142a described above engages.

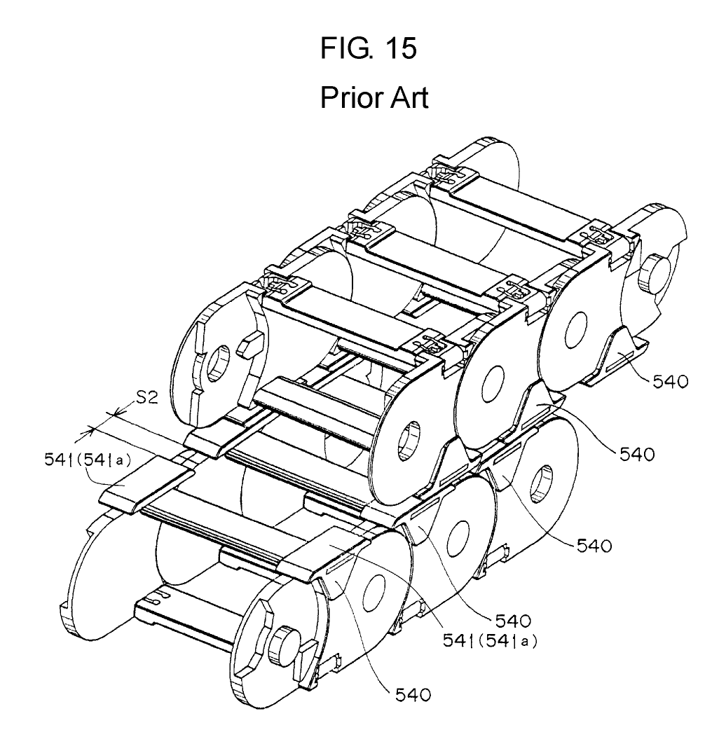

Because the slidable-contact bottom portions 141 of the shoes 140 provided on the flexed cable inner peripheral side of the link plates 110 have the parallelogram slidable-contact bottom surfaces 141a that slidably contact with each other, i.e., without engaging with each other, in the device 100 of the first embodiment thus obtained as shown in FIGS. 1 and 5, the mutual distance S1 of the adjacent shoes 140 in the upper and lower link plates on the flexed cable inner peripheral side is expanded by the distance by which the opposite sides of the parallelogram slidable-contact bottom surfaces 141a are staggered diagonally in parallel with each other, i.e., by which sides in the longitudinal direction of the parallelogram are shortened, as shown in FIG. 5 and the degree of freedom of flexibility of the link plates increases as compared to the mutual distance S2 of the prior art shoes 540 having the rectangular slidable-contact bottom surfaces 541a as shown in FIGS. 12 and 15.

Accordingly, it becomes possible to reduce a radius of flexion R1 based on an imaginary center axis O-O in bending back the train of link plates in the cable longitudinal direction between the cable fixing and moving ends as shown in FIG. 6 as compared to the radius of flexion R2 of the prior art device. Then, it becomes possible to downsize the device while keeping smooth move of the train of the link plates bent back in the cable longitudinal direction by continuously sliding the slidable-contact bottom portions 141 of the shoes 140.

Then, because the parallelogram slidable-contact bottom surfaces 141a of the shoes 140 are disposed so as to orient in the same direction between the pair of right and left link plates 110 in the present embodiment without requiring different kinds of shoes for the pair of right and left link plates 110, the shoes 140 may be formed into the single shape, an increase of numbers of parts may be suppressed and a burden for managing the parts may be reduced. Thus, the advantageous effects of the present embodiment are remarkable.

Next, a cable protecting and guiding device 200 of a second embodiment of the invention will be explained with reference to FIGS. 6 through 11. The cable protecting and guiding device 200 of the second embodiment of the invention shown in FIG. 6 is composed of a large number of link frames respectively connected in a cable longitudinal direction. Each link frame is composed of a pair of link plates 210 disposed apart in the lateral direction with connecting plates 220 and 230 bridged across the link plates 210 on the flexed cable outer and inner peripheral sides. The device 200 is arranged so that cables and the like (not shown) inserted through the link frames may be bent back in the cable longitudinal direction and be moved relatively between a cable fixing end (not shown) and a cable moving end (not shown).

Here, as shown in FIG. 7, a cutaway portion 211 and a convex portion 212 of the link plate 210 described above are arranged so that when the link frame is linked with an adjacent link frame, the cutaway portion 211 engages with the convex portion 212 of the adjacent link frame while the convex portion 212 engages with the cutaway portion 211 of the adjacent link frame. Thereby, a radius of flexion in the cable longitudinal direction is restricted so that it does not fall below a certain value.

While the material of the link plates 210, the connecting plates 220 and 230 is not specifically limited, it is preferable that the link plates 210 and the connecting plates 220 and 230 are molded from a glass fiber reinforced polyamide resin that exhibits excellent strength.

Next, a shoe 240 made of synthetic resin and provided on the flexed cable inner peripheral side of the link plate 210, which is the most characteristic part of the cable protecting and guiding device 200 of the present embodiment, will be explained in detail. That is, the shoe 240 shown in FIGS. 8 and 9 has a slidable-contact bottom portion 241 having a slidable-contact bottom surface 241a formed into a shape of parallelogram that allows the upper and lower shoes on the flexed cable inner peripheral side to slidably contact with each other, without engaging with each other, when a train of the link plates is bent back and moved. The shoe 240 also has a shoe outer wall portion 242 protruding from the slidable-contact bottom portion 241 to the side of the link plate 210 and a shoe inner wall portion 243 that removably engages with the link plate 210 in cooperation with the shoe outer wall portion 242.

Thereby, a mutual distance S1 in the cable longitudinal direction of the shoes 240 adjacent respectively in the upper and lower link plates 210 on the flexed cable inner peripheral side is expanded by a distance by which opposite sides of the parallelogram composing the slidable-contact bottom surface 241a are staggered diagonally in parallel with each other, i.e., by which sides in the longitudinal direction of the parallelogram are shortened, as shown in FIG. 11 and a degree of freedom of flexibility of the link plates increases. It is noted that imaginary lines in FIGS. 8 and 9 indicate an outer shape of the slidable-contact bottom portion 541 of the prior art shoe 510 as compared with the outer shape of the shoe 240 of the present embodiment.

The parallelogram slidable-contact bottom surfaces 141a of the shoes 240 described above are disposed so as to orient symmetrically in the lateral direction of the pair of right and left link plates 110. Thereby, the slidable contact bottom portions 241 of the shoes 240 facing with each other at the upper and lower sides of the flexed cable inner peripheral side slidably contact evenly in the lateral direction between the pair of right and left link plate 210.

It is noted that the shoe 240 shown in FIGS. 8 and 9 has a horizontally long hook 242a provided on an inner side surface of the shoe outer wall portion 242 described above, a horizontally long projection 244 provided closely with the shoe inner wall portion 243 described above and an indicator 241b provided on a side surface of the slidable-contact bottom portion 241 described above to check a state of wear of the shoe. FIG. 10 shows an insertion hole 213 into which the shoe inner wall portion 243 and the projection 244 described above are inserted and a concave 214 with which the hook 242a described above engages.

Because the slidable-contact bottom portions 241 of the shoes 240 provided on the flexed cable inner peripheral side of the link plates 210 that slidably contact with each other has the parallelogram slidable-contact bottom surface 241a in the device 200 as shown in FIGS. 6 and 11, the mutual distance S1 of the adjacent shoes 240 respectively in the upper and lower link plates on the flexed cable inner peripheral side as shown in FIG. 11 is expanded by the distance by which the opposing sides of the parallelogram slidable-contact bottom surfaces 241a are staggered diagonally in parallel with each other as shown in FIG. 11 and the degree of freedom of flexibility of the link plates increases as compared to the mutual distance S2 of the prior art shoes 540 having the rectangular slidable-contact bottom surfaces 541a as shown in FIGS. 12 and 15. Accordingly, it becomes possible to reduce a radius of flexion R1 based on an imaginary center axis O-O in bending back the train of link plates in the cable longitudinal direction between the cable fixing and moving ends as compared to the radius of flexion R2 of the prior art device and then to downsize the device while keeping smooth move of the train of the link plates bent back in the cable longitudinal direction by continuously sliding the slidable-contact bottom portions 241 of the opposing shoes 240 on the flexed cable inner peripheral side.

Then, because the parallelogram slidable-contact bottom surfaces 241a of the shoes 240 are disposed so as to orient symmetrically in the lateral direction of the pair of right and left link plates 210, the slidable-contact bottom portions 241 of the shoes 240 facing respectively on the upper and lower sides of the flexed cable inner peripheral side slidably contact evenly in the lateral direction between the pair of right and left link plates. Accordingly, it becomes possible to attain stable relative move of the train of the link frames bent back without oblique in the cable longitudinal direction. Thus, the advantageous effects of the present embodiment are remarkable.

The specific mode of the cable protecting and guiding device of the present invention may take a variety of modes without departing from the meaning and scope of the claims.

For example, the specific material of the link plate used for the cable protecting and guiding device of the invention may be either material of synthetic resin such as engineering resin or metal such as aluminum. Still more, the specific shape of the link plate may have any shape as long as the link plate composes part of the link frame and allows the cables and the like inserted through the link frames to be bent back in the cable longitudinal direction and moved relatively between the cable fixing and cable moving ends.

Still more, the specific material of the shoes used in the cable protecting and guiding device of the invention may be any synthetic resin such as the engineering resin that exhibits excellent self-lubricant property. The specific shape of the shoe may be any shape as long as the slidable-contact bottom portion thereof has the parallelogram slidable-contact bottom surface that slidably contacts at the upper and lower parts of the flexed cable inner peripheral side. For example, the parallelogram slidable-contact bottom surface may be either shape that is disposed so as to orient in the same direction between the pair of right and left link plates or that is disposed so as to orient symmetrically in the lateral direction with each other.

What is claimed is:

1. A cable protecting and guiding device comprising a plurality of link frames;
each link frame being composed of a pair of link plates disposed apart in a lateral direction with a pair of connecting plates bridged across the link plates on a flexed cable outer and a inner peripheral side, respectively;
said plurality of link frames being linked together in a cable longitudinal direction;
wherein the link frames are bent back and moved together in a stacked manner in the cable longitudinal direction; and
a slidable-contact bottom portion of a shoe provided on the flexed cable inner peripheral side of the link plate, the slidable-contact bottom portion having a parallelogram shape and being configured to slidably contacts with a slidable-contact bottom surface of an opposing shoe of another link frame on the flexed cable inner peripheral side when the link frames are bent back and moved together in the stacked manner.

2. The cable protecting and guiding device according to claim 1, wherein the slidable-contact bottom surfaces of said pair of right and left link plates are oriented in the same direction.

3. The cable protecting and guiding device according to claim 1, wherein the slidable-contact bottom surfaces of said pair of right and left link plates are oriented so as to be symmetrical in the lateral direction with each other.

4. A cable protecting and guiding device comprising a plurality of link frames;
each link frame being composed of a pair of link plates disposed apart in a lateral direction with a pair of connecting plates bridged across the link plates on a flexed cable outer and a inner peripheral side, respectively, wherein the link frame comprises a box-shape which is configured to house a cable therein; and
a slidable-contact bottom portion of a shoe provided on the flexed cable inner peripheral side of the link plate, the slidable-contact bottom portion having a parallelogram shape,
wherein the plurality of link plates of the link frames are linked together in a cable longitudinal direction, and
wherein the link frames are bent back and moved together in a stacked manner in the cable longitudinal direction; and
wherein the slidable-contact bottom portion is configured to slidably contact with a slidable-contact bottom surface of an opposing shoe of another link frame on the flexed cable inner peripheral side when the link frames are bent back and moved together in the stacked manner.

5. The cable protecting and guiding device according to claim 4, wherein the slidable-contact bottom surfaces of said pair of right and left link plates are oriented in the same direction.

6. The cable protecting and guiding device according to claim 4, wherein the slidable-contact bottom surfaces of said pair of right and left link plates are oriented so as to be symmetrical in the lateral direction with each other.
